(19) United States
(12) Patent Application Publication
(10) Pub. No.: US 2025/0291181 A1
(43) Pub. Date: Sep. 18, 2025

(54) HEAD-UP DISPLAY

(71) Applicant: Panasonic Automotive Systems Co., Ltd., Kanagawa (JP)

(72) Inventor: Tomoaki MIYAMOTO, Osaka (JP)

(73) Assignee: Panasonic Automotive Systems Co., Ltd., Kanagawa (JP)

(21) Appl. No.: 19/045,855

(22) Filed: Feb. 5, 2025

(30) Foreign Application Priority Data
Mar. 12, 2024 (JP) 2024-038125

(51) Int. Cl. G02B 27/01

(52) U.S. Cl. CPC G02B 27/0101

(57) ABSTRACT

A head-up display that projects an image onto an object capable of transmitting or reflecting light, and forms a virtual image on a side opposite an observer relative the object, is a head-up display that includes: an image generation device that projects the image; and a projection optical system that guides the image projected onto the object, and forms the virtual image. The projection optical system includes a first optical element and a second optical element provided in order along a light path on which the image generation device projects the image. The virtual image is inclined to cause an upper side of the virtual image, in an up-and-down direction of the virtual image as viewed by the observer, to appear farther away. An intensity of combined power in a left-and-right direction of the virtual image as viewed by the observer is greater than that of the up-and-down direction.

### CROSS REFERENCE TO RELATED APPLICATION

The present application is based on and claims priority of Japanese Patent Application No. 2024-038125 filed on Mar. 12, 2024.

### FIELD

The present disclosure relates to a head-up display.

### BACKGROUND

Conventionally, there exists a so-called Slope-Head-Up Display (HUD) that allows an observer to view a virtual image that has been inclined. Patent Literature (PTL) 1 describes a technique related to a Slope-HUD that includes a first optical element, for which a diverging effect in a horizontal direction is greater than a diverging effect in an up-and-down direction, and a second optical element, for which a converging effect in the horizontal direction is greater than a converging effect in the up-and-down direction.

### CITATION LIST

### Patent Literature

PTL 1: Japanese Patent No. 7190653

### SUMMARY

However, the head-up display described in the above-mentioned PTL 1 can be improved upon.

In view of this, in the present disclosure, a head-up display that can further improve upon the related art is provided.

A head-up display according to the present disclosure is a head-up display that projects an image onto an object capable of at least reflecting light, and forms a virtual image on a side opposite an observer with respect to the object, and the head-up display includes: an image generation device that projects the image; and a projection optical system that guides the image projected onto the object, and forms the virtual image, wherein the projection optical system includes a first optical element and a second optical element provided in order along a light path on which the image generation device projects the image, the virtual image is inclined to cause an upper side of the virtual image, in an up-and-down direction of the virtual image as viewed by the observer, to appear farther away, and an intensity of combined power in a left-and-right direction of the virtual image as viewed by the observer is greater than an intensity of combined power in the up-and-down direction of the virtual image.

The head-up display according to the present disclosure can further improve upon the related art.

### BRIEF DESCRIPTION OF DRAWINGS

These and other advantages and features of the present disclosure will become apparent from the following description thereof taken in conjunction with the accompanying drawings that illustrate specific embodiments of the present disclosure.

FIG. 1 is a schematic diagram illustrating a cross section of a vehicle in which a head-up display according to Embodiment 1 is provided.

FIG. 2 is a schematic diagram illustrating a cross section of a vehicle in which a head-up display according to Embodiment 2 is provided.

### DESCRIPTION OF EMBODIMENTS

Hereinafter, embodiments of a head-up display according to the present disclosure will be described with reference to the drawings. It should be noted that the following embodiments are merely examples for describing the present disclosure, and are not intended to limit the scope of the present disclosure. For example, the shapes, structures, materials, elements, relative positional relationships, connection states, numerical values, formulas, and details of each of the steps and the order of the steps of the methods, and the like, described in the following embodiments are mere examples, and may include details that are not included in the following descriptions. Furthermore, although geometric expressions, such as “parallel” and “orthogonal”, may be used, these expressions are not mathematically precise indications and include substantially permissible error, deviation, and the like. Moreover, expressions, such as “simultaneous” and “identical (or the same)”, are considered to cover a substantially permissible range of meaning.

Additionally, the drawings are schematic illustrations, which may include emphasis, omission, or adjustment of proportion as necessary for the purpose of illustrating the present disclosure, and thus the shapes, positional relationships, and proportions shown may be different from actuality. Furthermore, an X-axis, Y-axis, and Z-axis, which may be shown in the figures indicate orthogonal coordinates that have been set in an arbitrary manner for the purpose of describing the figures. That is to say, a Z-axis is not necessarily an axis that extends in a vertical direction, and X and Y axes do not necessarily lie within a horizontal plane.

Furthermore, hereinafter, multiple aspects may be comprehensively described as a single embodiment. Moreover, part of the contents in the description below describes optional elements related to the present disclosure.

### Embodiment 1

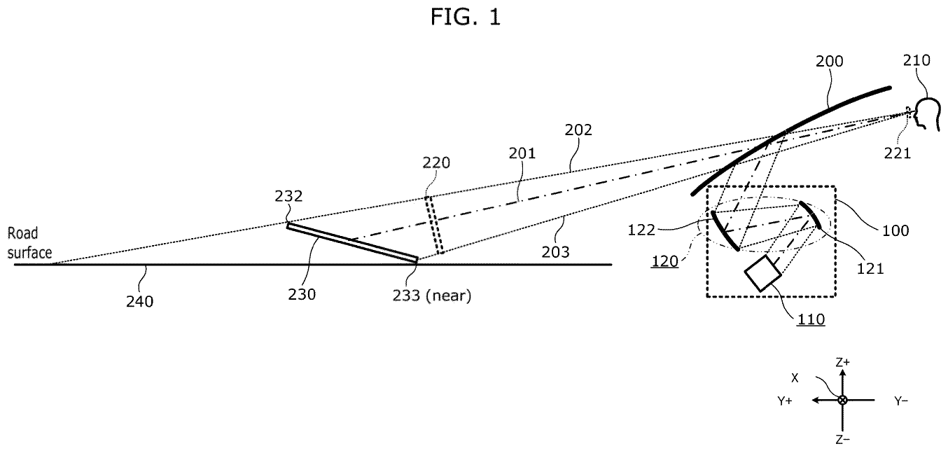

FIG. 1 is a schematic diagram illustrating a cross section of a vehicle in which head-up display 100 according to Embodiment 1 is provided. It should be noted that in the coordinate axes illustrated in FIG. 1, an X-axis, Y-axis, and Z-axis are tentatively defined as respectively representing a widthwise direction, a front-and-back direction, and an up-and-down direction of the vehicle itself, and such axes do not necessarily coincide with the individual axes that are defined for each optical element.

Head-up display 100 is a device that projects an image formed by light projected onto object 200 that allows light to pass through and is capable of reflecting light, and virtually forms virtual image 230, which can be viewed by observer 210, in virtual image region 220 that is virtually generated on the other side of object 200 relative to observer 210. Head-up display 100 includes image generation device 110 and projection optical system 120. The object in which head-up display 100 is installed is not particularly limited, and examples include vehicles, such as automobiles, buses, and trucks.

Note that in the present embodiment, central light beam 201 passes through the center of eye box 221 of observer 210. Eye box 221 is a region that includes an eye point and which is assumed in advance to be a spatial region in which virtual image 230 can be viewed by observer 210 while observer 210 is seated in the driver seat and driving.

In the present embodiment, head-up display 100 is a Slope-HUD that displays virtual image 230 along road surface 240. Head-up display 100 is capable of providing an augmented reality (AR) display that is natural and that evokes a perception of depth, and can improve cognition of observer 210 (driver).

Object 200 is not particularly limited as long as it is a component that is capable of at least reflecting light. In the present embodiment, object 200 is a windshield (windproof glass) that is disposed in front of observer 210 in the vehicle cabin, and is a component on which the image projected by image generation device 110 is displayed. Head-up display 100 is disposed on a vehicle component, such as a dashboard of a vehicle, and projects the image from inside the vehicle cabin onto object 200. Accordingly, object 200 forms virtual image 230 in virtual image region 220 that is on the side of object 200 opposite of observer 210 (outside vehicle cabin). Observer 210 can view both the scenery that is visible through object 200 and virtual image 230 that are overlaid on each other. The dash-dotted line shown in FIG. 1 illustrates central light beam 201 that is a light beam that passes through the center of virtual image region 220 that is a region in which virtual image 230 that is viewable by observer 210 can be formed. It should be noted that the position of central light beam 201 is not clearly defined, and may change depending on the size, posture, seat position, and the like of observer 210.

Projection optical system 120 is a device that guides the image projected by image generation device 110 onto object 200, and includes optical elements designed to form virtual image 230 by using object 200. Projection optical system 120 includes first optical element 121 and second optical element 122 provided in order along a light path on which image generation device 110 projects the image.

Here, in the present disclosure, “front” refers to the direction (Y+ side in the figures) toward which object 200 (windshield) is located when viewed by observer 210. “Rear” refers to the direction that is opposite the front (Y− side in the figures).

Among light beams that are emitted d from image generation device 110 and reach the center of eye box 221, a light beam equivalent to upper edge 232 of virtual image 230 is referred to as upper light beam 202, and a light beam equivalent to lower edge 233 of virtual image 230 is referred to as lower light beam 203. Furthermore, among light beams that are emitted from image generation device 110, a light beam that passes through the central portion of virtual image 230 and reaches the center of eye box 221 is referred to as central light beam 201. In other words, when viewed by observer 210, central light beam 201 is equivalent to the light path that is traced from the center of virtual image 230 to the viewpoint of observer 210. In reality, central light beam 201, which is viewed by observer 210, is a light beam from image generation device 110 that reaches observer 210 via projection optical system 120 and object 200. For this reason, even the light beam that reaches observer 210 from image generation device 110, which corresponds to central light beam 201 that appears to be emitted from the center of virtual image 230, is described as central light beam 201. Furthermore, the light path that corresponds to these light beams can likewise be represented by central light beam 201. However, it is assumed that the viewpoint of observer 210 is located at the center of eye box 221. It should be noted that the positions through which each of central light beam 201, upper light beam 202, and lower light beam 203 pass through are not clearly defined, and may change depending on the size, posture, seat position, and the like of observer 210. The direction corresponding to a direction that connects upper edge 232 of virtual image 230 and lower edge 233 of virtual image 230 is the up-and-down direction and a direction that is orthogonal to the up-and-down direction and central light beam 201 is the left-and-right direction. In other words, the image that passes through or is reflected in each optical element corresponds to virtual image 230, the up-and-down direction of the image (corresponding to virtual image 230) projected onto each optical element is the up-and-down direction of each optical element, and the left-and-right direction of the image (virtual image 230) is the left-and-right direction of each optical element.

Projection optical system 120 is set to incline virtual image 230 such that an upper side of virtual image 230 appears farther away in the up-and-down direction of virtual image 230 as viewed by the observer. In projection optical system 120, an intensity of combined power in the left-and-right direction of virtual image 230 (X-axis direction in the figures) as viewed by observer 210 is greater than an intensity of combined power in the up-and-down direction of virtual image 230.

In the present embodiment, power in the left-and-right direction of object 200 is at least four times as much as power in the up-and-down direction of object 200. Specifically, in object 200 that is provided as a windshield in a relatively compact vehicle, the power in the left-and-right direction is often at least 4.7 times and less than 12.5 times as much as the power in the up-and-down direction, in portions and the vicinity of portions onto which an image is emitted. A projection optical system 120 that corresponds to such an object 200 includes first optical element 121 having positive power in the left-and-right direction in at least the vicinity of central light beam 201. According to this configuration, the light path can be extended and interference of optical elements with the light path can be avoided. It should be noted that having negative power refers to having a diverging effect and having positive power refers to having a converging effect.

In the present embodiment, head-up display 100 is set so as to have a positive combined power in a left-and-right direction and a negative combined power in an up-and-down direction. Furthermore, head-up display 100 is set so as to have positive combined power in the left-and-right direction and positive combined power in the up-and-down direction when the reflective surface of object 200 is included. It should be noted that the power of head-up display 100 is primarily determined by the combined power of projection optical system 120.

In the present embodiment, in first optical element 121 included in projection optical system 120, power in an up-and-down direction is greater than power in a left-and-right direction, and in second optical element 122, power in an up-and-down direction is greater than power in a left-and-right direction.

Image generation device 110 is a device that forms an image that corresponds to virtual image 230, and projects the image onto object 200 via projection optical system 120, and is a projector referred to as a picture generation unit (PGU) or the like. In the present embodiment, image generation device 110 includes a display component (not illustrated in the figures) that forms the image corresponding to virtual image 230. Although the display component is not particularly limited, examples of the display component include a case where image generation device 110 involves a thin film transistor liquid crystal display (TFT LC) method, i.e., a liquid crystal panel that includes liquid crystals arranged in a matrix or the like, and a case where image generation device 110 is a digital micro-mirror device (DMD), i.e., a semiconductor panel or the like on which a large number of movable microscopic mirror surfaces (micro-optical elements) have been integrated. It should be noted that a diffusion panel that diffuses laser light for forming an image suitable for virtual image 230 may be included as a display component.

Furthermore, image generation device 110 includes a light source (not illustrated in the figures) that generates light that is projected as an image onto object 200. Although the light source is not particularly limited, examples include a light emitting diode (LED), a laser diode (LD), or the like. When an organic light-emitting diode (OLED) is used, a display component and a light source may be provided as an integral unit. Image generation device 110 includes a lighting optical system (not illustrated in the figures) that is separate from projection optical system 120. The lighting optical system is a device that includes a single optical element or a plurality of optical elements designed such that light emitted by the light source include light beams (parallel light, for example) appropriate for forming virtual image 230. The optical element is not particularly limited, and examples include a convex lens, concave lens, Fresnel lens, prism, convex mirror, concave mirror, or the like.

For example, when image generation device 110 is provided in a vehicle, image generation device 110 generates an image that is viewed by observer 210 as virtual image 230. Examples of the image include road travel guidance information, distance to a vehicle in front, remaining amount of battery charge, and current vehicle speed, for example.

In the present embodiment, image generation device 110 includes a display component that has been titled so as to make virtual image 230 that is inclined visible to the observer.

### Embodiment 2

Next, the operation of head-up display 100 according to another embodiment will be described. It should be noted that elements that achieve the same effects and functions as Embodiment 1, and elements (portions) that have the same shapes, mechanisms, and structures as Embodiment 1 are given the same reference signs and descriptions thereof may be omitted. Furthermore, descriptions of projection optical system 120, which include the points of difference with Embodiment 1, are hereinafter provided, and descriptions of image generation device 110, which are redundant, will be omitted.

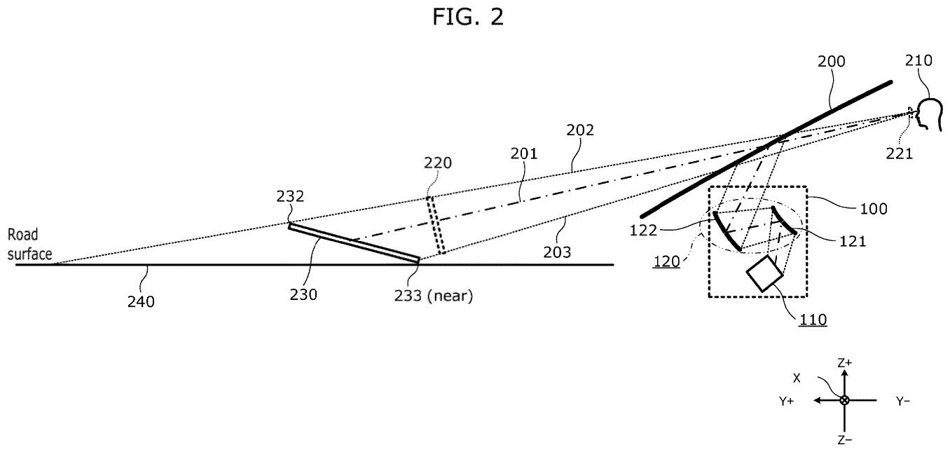

FIG. 2 is a schematic diagram illustrating a cross section of a vehicle in which head-up display 100 according to Embodiment 2 is provided. A case is illustrated in which power in a left-and-right direction of object 200 is less than four times as much as power in an up-and-down direction of object 200. Specifically, in object 200 that is provided as a windshield in a relatively large-scale vehicle, in portions and the vicinity of portions onto which an image is emitted, power in the left-and-right direction is often at least 2.9 times and less than four times as much as power in the up-and-down direction. A projection optical system 120 that corresponds to such an object 200 includes first optical element 121 having positive power in the left-and-right direction in at least the vicinity of central light beam 201. On the other hand, second optical element 122 has negative power. In other words, projection optical system 120 according to Embodiment 2 is a telephoto lens.

In the present embodiment, projection optical system 120 is set so as to have combined power in a left-and-right direction that is positive and combined power in an up-and-down direction that is positive. Furthermore, projection optical system 120 is set so as to have positive combined power in the left-and-right direction and the up-and-down direction when the reflective surface of object 200 is included. Furthermore, in first optical element 121 provided in projection optical system 120, power in an up-and-down direction is less than power in a left-and-right direction, and in second optical element 122, power in an up-and-down direction is less than power in a left-and-right direction. The combined power in the up-and-down direction of projection optical system 120 is slightly negative.

In head-up display 100 according to Embodiment 2, when power in an up-and-down direction of object 200 is weak, a telephoto configuration can be used to make power in a left-and-right direction of projection optical system 120 strong and to make the light path in head-up display 100 short, thereby allowing the overall shape of head-up display 100 to become compact. The reflective surface of object 200 is a gently curved convex surface, and has a slightly positive power. With head-up display 100 according to Embodiment 2, when the combined power of the overall optical system of object 200 and head-up display 100 is made to be positive, virtual image 230 can be magnified. Furthermore, since power in the up-and-down direction of projection optical system 120 within head-up display 100 is negative, the combined power of the overall optical system of object 200 and head-up display 100 becomes the weakest, which is advantageous from the standpoint of optical aberration.

Moreover, the present disclosure is not limited to the above-mentioned embodiments. For example, other embodiments produced by arbitrarily combining or omitting some elements described in the present Description may be included as embodiments of the present disclosure. Moreover, the present disclosure includes variations obtained by various modifications to the above embodiment that can be conceived by those skilled in the art, so long as they do not depart from the essence of the present disclosure, that is, the intended meaning of the appended Claims.

For example, even when power in the left-and-right direction of object 200 is less than four times as much as power in the up-and-down direction of object 200, a projection optical system 120 that includes a first optical element 121 having negative power in the left-and-right direction and a second optical element 122 having negative power may be used in at least the vicinity of central light beam 201. Furthermore, even when power in the left-and-right direction of object 200 is at least four times as much as power in the up-and-down direction of object 200, a projection optical system 120 that includes a first optical element 121 having positive power in the left-and-right direction and a second optical element 122 having negative power may be used in at least the vicinity of central light beam 201.

Furthermore, first optical element 121 may be flat in the left-and-right direction, or in other words, may be an optical element having no power, and may have power in the left-and-right direction of 0.002 or less (radius of curvature of at least 1,000 mm).

### SUMMARY

Head-up display 100 according to a first aspect is a head-up display that projects an image onto object 200 capable of at least reflecting light, and forms virtual image 230 on a side opposite observer 210 with respect to object 200, and head-up display 100 includes: image generation device 110 that projects the image; and projection optical system 120 that guides the image projected onto object 200, and forms virtual image 230. Projection optical system 120 includes first optical element 121 and second optical element 122 provided in order along a light path on which image generation device 110 projects the image. Virtual image 230 is inclined to cause an upper side of virtual image 230, in an up-and-down direction of virtual image 230 as viewed by observer 210, to appear farther away. An intensity of combined power in a left-and-right direction of virtual image 230 as viewed by observer 210 is greater than an intensity of combined power in the up-and-down direction of virtual image 230.

The first aspect is based on knowledge obtained by the inventors indicating that since the length in the left-and-right direction of upper edge 232 (far side) of virtual image 230 of head-up display 100 becomes greater in a case where an inclined virtual image 230 is made visible to observer 210 compared to a case where virtual image 230 is not inclined, this makes it possible to achieve the same magnification rate even when combined power in the up-and-down direction of object 200 and projection optical system 120 of head-up display 100 is less than that of a case where virtual image 230 is upright. Accordingly, power in the up-and-down direction of projection optical system 120 can be made smaller, thereby enhancing the degree of freedom for designing projection optical system 120.

Furthermore, since the magnification rate in the up-and-down direction is reduced by lowering power in the up-and-down direction of projection optical system 120, or in other words, increasing the combined focal length in the up-and-down direction, it is possible to reduce deviation from an ideal viewing distance in the up-and-down direction of virtual image 230. Furthermore, it is possible to reduce longitudinal optical aberrations involving image surface curvature and the like in the up-and-down direction of virtual image 230.

Head-up display 100 according to a second aspect is head-up display 100 according to the first aspect, in which, when power in a left-and-right direction of object 200 is at least four times as much as power in an up-and-down direction of object 200, first optical element 121 has negative power.

Head-up display 100 according to a third aspect is head-up display 100 according to the second aspect, in which, in projection optical system 120, combined power in a left-and-right direction is positive and combined power in an up-and-down direction is negative.

According to the second aspect and the third aspect, head-up display 100 can be applied to an object 200 to be installed in a relatively compact vehicle (for example, a “kei” car, a car with an engine displacement of 1,000 cc, or the like).

Head-up display 100 according to a fourth aspect is head-up display 100 according to the first aspect, in which, when power in a left-and-right direction of object 200 is less than four times as much as power in an up-and-down direction of object 200, first optical element 121 has positive power.

Head-up display 100 according to a fifth aspect is head-up display 100 according to the fourth aspect, in which, in projection optical system 120, combined power in a left-and-right direction is positive and combined power in an up-and-down direction is positive.

According to the fourth aspect and the fifth aspect, head-up display 100 can be applied to an object 200 to be installed in a relatively large-scale vehicle (for example, a car with an engine displacement of no less than 2,000 cc, bus, truck, or the like).

Head-up display 100 according to a sixth aspect is head-up display 100 according to any one of the first through fifth aspects, in which, in projection optical system 120, when a reflective surface of object 200 is included, combined power in a left-and-right direction and combined power in an up-and-down direction are positive.

According to the sixth aspect, virtual image 230 that is inclined can be appropriately made visible to observer 210.

Head-up display 100 according to a seventh aspect is head-up display 100 according to the second aspect, in which, in first optical element 121, power in an up-and-down direction is greater than power in a left-and-right direction, and in second optical element 122, power in an up-and-down direction is greater than power in a left-and-right direction.

Head-up display 100 according to an eighth aspect is head-up display 100 according to the fourth aspect, in which, in first optical element 121, power in an up-and-down direction is less than power in a left-and-right direction, and in second optical element 122, power in an up-and-down direction is less than power in a left-and-right direction.

According to the seventh aspect and the eighth aspect, virtual image 230 that is inclined can be appropriately made visible to observer 210 depending on whether the power of first optical element 121 is positive or negative.

While various embodiments have been described herein above, it is to be appreciated that various changes in form and detail may be made without departing from the spirit and scope of the present disclosure as presently or hereafter claimed.

Further Information about Technical Background to this Application

The disclosure of the following patent application including specification, drawings, and claims is incorporated herein by reference in its entirety: Japanese Patent Application No. 2024-038125 filed on Mar. 12, 2024.

### INDUSTRIAL APPLICABILITY

The head-up display according to the present disclosure is suitable for in-vehicle use.

1. A head-up display that projects an image onto an object capable of at least reflecting light, and forms a virtual image on a side opposite an observer with respect to the object, the head-up display comprising:
an image generation device that projects the image; and
a projection optical system that guides the image projected onto the object, and forms the virtual image, wherein
the projection optical system includes a first optical element and a second optical element provided in order along a light path on which the image generation device projects the image,
the virtual image is inclined to cause an upper side of the virtual image, in an up-and-down direction of the virtual image as viewed by the observer, to appear farther away, and
an intensity of combined power in a left-and-right direction of the virtual image as viewed by the observer is greater than an intensity of combined power in the up-and-down direction of the virtual image.

2. The head-up display according to claim 1, wherein
when power in a left-and-right direction of the object is at least four times as much as power in an up-and-down direction of the object, the first optical element has negative power.

3. The head-up display according to claim 2, wherein
in the projection optical system, combined power in a left-and-right direction is positive and combined power in an up-and-down direction is negative.

4. The head-up display according to claim 1, wherein
when power in a left-and-right direction of the object is less than four times as much as power in an up-and-down direction of the object, the first optical element has positive power.

5. The head-up display according to claim 4, wherein
in the projection optical system, combined power in a left-and-right direction is positive and combined power in an up-and-down direction is positive.

6. The head-up display according to claim 1, wherein
in the projection optical system, when a reflective surface of the object is included, combined power in a left-and-right direction and combined power in an up-and-down direction are positive.

7. The head-up display according to claim 2, wherein
in the first optical element, power in an up-and-down direction is greater than power in a left-and-right direction, and
in the second optical element, power in an up-and-down direction is greater than power in a left-and-right direction.

8. The head-up display according to claim 4, wherein
in the first optical element, power in an up-and-down direction is less than power in a left-and-right direction, and
in the second optical element, power in an up-and-down direction is less than power in a left-and-right direction.

9. The head-up display according to claim 1, wherein
in the first optical element, power in a left-and-right direction of the first optical element is no more than 0.002.
